(19) United States
(12) Patent Application Publication
(10) Pub. No.: US 2021/0095862 A1
(43) Pub. Date: Apr. 1, 2021

(54) HEATING COOKING DEVICE

(71) Applicant: Panasonic Intellectual Property Management Co., Ltd., Osaka (JP)

(72) Inventors: TAKESHI NAKASHIMA, Shiga (JP); HIROKI HAYASHI, Shiga (JP); TAKUZO SHIMIZU, Shiga (JP)

(21) Appl. No.: 17/044,830

(22) PCT Filed: Apr. 22, 2019
(86) PCT No.: PCT/JP2019/016914

§ 371 Date: Oct. 1, 2020

(30) Foreign Application Priority Data
Apr. 27, 2018 (JP) 2018-085909

(51) Int. Cl. F24C 15/00; F24C 7/02; F24C 7/04

(52) U.S. Cl. CPC F24C 15/008; F24C 15/004; F24C 7/04; F24C 7/02

(57) ABSTRACT

A heating cooking device includes: heating chamber having front face opening; and a heater to heat object to be heated stored in heating chamber. The heating cooking device further includes: camera that has optical axis inclined with respect to a vertical direction and is disposed on upper wall of heating chamber to face inside of heating chamber; and first illuminator that illuminates the inside of heating chamber from a side of upper wall of heating chamber. The heating cooking device further includes top panel that is disposed below upper wall of heating chamber, is formed of a semitransparent member to illuminate downward while diffusing light from first illuminator, and is provided with top panel opening serving as an opening through which camera images the inside of heating chamber.

### TECHNICAL FIELD

The present invention relates to a heating cooking device for heating food.

### BACKGROUND ART

Conventionally, there is a heating cooking device including an imaging unit to image inside of the chamber (for example, see PTL 1). That heating cooking device includes, on a ceiling of a heating chamber, an imaging unit to capture an image, and the heating cooking device further includes an illuminator to increase an amount of light for stable imaging.

### CITATION LIST

### Patent Literature

PTL 1: Unexamined Japanese Patent Publication No. S59-044793

### SUMMARY OF THE INVENTION

However, for example, when a tall object to be heated is imaged in such a configuration, light from the illuminator disposed on the ceiling is reflected by an upper part of the object to be heated, so that strong halation is caused in a captured image.

To avoid such halation, another configuration may be considered in which the inside of the chamber is illuminated only with an illuminator on a side wall to avoid the illumination from the ceiling. However, in such a way, an enough amount of light cannot be supplied to the upper surface of the tall object to be heated, so that imaging accuracy becomes low.

A heating cooking device in the present disclosure includes a heating chamber having a front face opening and a heater that heats an object to be heated stored in the heating chamber. The heating cooking device further includes: a camera that has an optical axis inclined with respect to a vertical direction and is disposed on an upper wall of the heating chamber to face inside of the heating chamber; and a first illuminator that radiates light toward the inside of the heating chamber from a position near the upper wall of the heating chamber. The heating cooking device further includes a top panel that is disposed below the upper wall of the heating chamber, includes a semitransparent member that diffuses the light from the first illuminator to illuminate downward, and includes a top panel opening serving as an opening through which the camera images the inside of the heating chamber.

The present disclosure can prevent or reduce halation by disposing an imaging unit on an upper surface in the chamber in an inclined manner and by providing a soft surface illuminator on the upper surface in the chamber. This arrangement improves imaging accuracy of the heating cooking device.

### BRIEF DESCRIPTION OF DRAWINGS

FIG. 1 is a perspective view of a heating cooking device according to one aspect of the present disclosure.

FIG. 2 is a perspective view showing the heating cooking device according to the one aspect of the present disclosure with a door opened.

FIG. 3 is a front view showing the heating cooking device according to the one aspect of the present disclosure with the door removed.

FIG. 4 is a perspective view from below showing the heating cooking device according to the one aspect of the present disclosure with the door removed.

FIG. 5 is a perspective view showing the heating cooking device according to the one aspect of the present disclosure with a part of a chassis removed.

FIG. 6 is a top view showing the heating cooking device according to the one aspect of the present disclosure with a part of the chassis removed.

FIG. 7 is a cross-sectional view taken along line 7-7 of FIG. 6.

FIG. 8 is a cross-sectional view taken along line 8-8 of FIG. 6.

FIG. 9 is a cross-sectional view taken along line 9-9 of FIG. 6.

FIG. 10 is a cross-sectional view taken along line 10-10 of FIG. 7.

FIG. 11 is an exploded perspective view of main components of the heating cooking device according to the one aspect of the present disclosure.

FIG. 12 is an exploded perspective view, viewed from below, of main components of the heating cooking device according to the one aspect of the present disclosure.

FIG. 13 is a top view explanatory diagram for illustrating a configuration of the heating cooking device according to the one aspect of the present disclosure.

FIG. 14 is an explanatory diagram of a front view for illustrating the configuration of the heating cooking device according to the one aspect of the present disclosure.

FIG. 15 is a side view explanatory diagram for illustrating the configuration of the heating cooking device according to the one aspect of the present disclosure.

FIG. 16 is a side view explanatory diagram for illustrating the configuration of the heating cooking device according to the one aspect of the present disclosure.

FIG. 17 is a side view explanatory diagram for illustrating the configuration of the heating cooking device according to the one aspect of the present disclosure.

### DESCRIPTION OF EMBODIMENTS

### First Exemplary Embodiment

### Overall Configuration

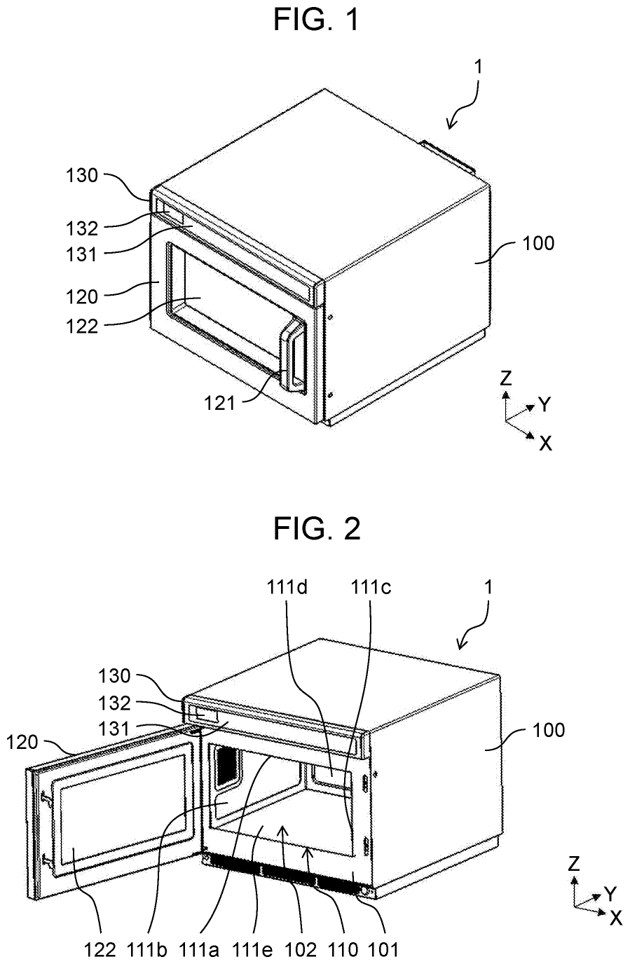

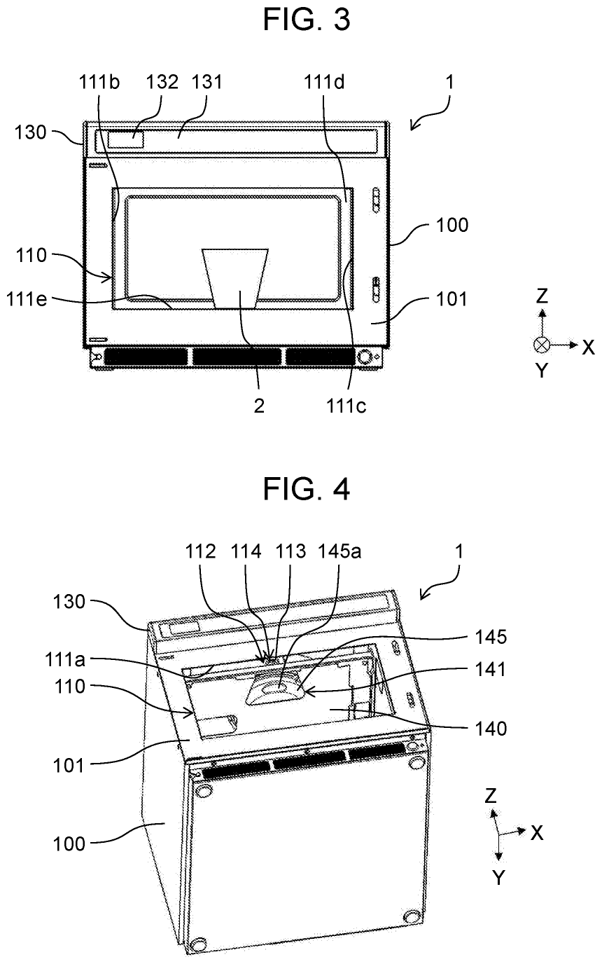

FIGS. 1 to 17 each show a heating cooking device according to one aspect of the present disclosure.

As shown in FIGS. 1 to 3, heating cooking device 1 according to the one aspect of the present disclosure has; chassis 100; heating chamber 110 disposed in chassis 100; and door 120 openably covering front face opening 102 located on front frame 101 serving as a front face of chassis 100.

In the description of the present disclosure, a side of front face opening 102 of heating cooking device 1 is assumed to be a front side, and a back face side, which is the opposite side, is assumed to be a rear side. Further, when viewed from the front side, in other words, in a front view, a top surface side of heating cooking device 1 is assumed to be an upper side, and a bottom face side is assumed to be a lower side. Further, in the front view, a right direction from heating cooking device 1 is assumed to be a right side, and a left direction is assumed to be a left side.

In the front view of heating cooking device 1, the right direction is assumed to be X direction, and the left direction is assumed to be −X direction. A rear direction and a front direction of heating cooking device 1 are respectively assumed to be Y direction and −Y direction. An upper direction and a lower direction of heating cooking device 1 are respectively assumed to be Z direction and −Z direction.

Heating chamber 110 has: upper wall 111a disposed on an upper part of heating chamber 110; left-side wall 111b and right-side wall 111c each disposed on one of both parts on the right and left of heating chamber 110; back wall 111d disposed on a rear part of heating chamber 110; and bottom wall 111e disposed on a lower part of heating chamber 110. In heating chamber 110 there is formed a space.

Door 120 is attached to chassis 100 on the left side of front face opening 102 in an openable manner about a rotation center in the vertical direction. Door 120 has handle 121 on a right end part of a front surface of door 120. When handle 121 is pulled by a user, door 120 is rotationally operated, and front face opening 102 is opened. Further, when handle 121 is pushed by a user, front face opening 102 is closed. Door 120 is provided with glass window 122 through which a user can check condition in heating chamber 110.

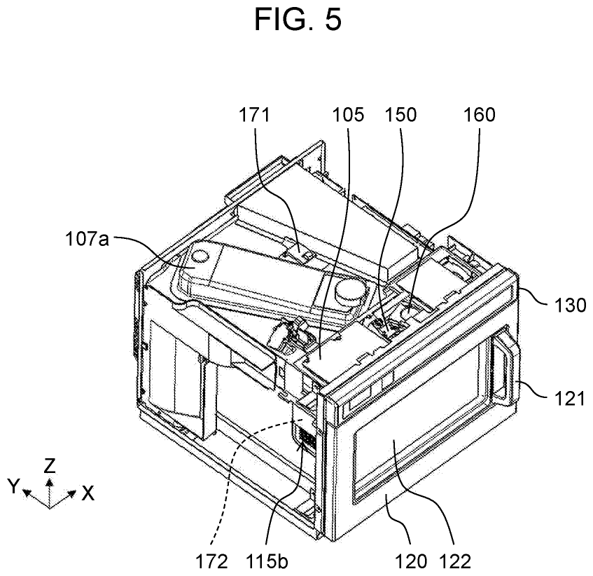

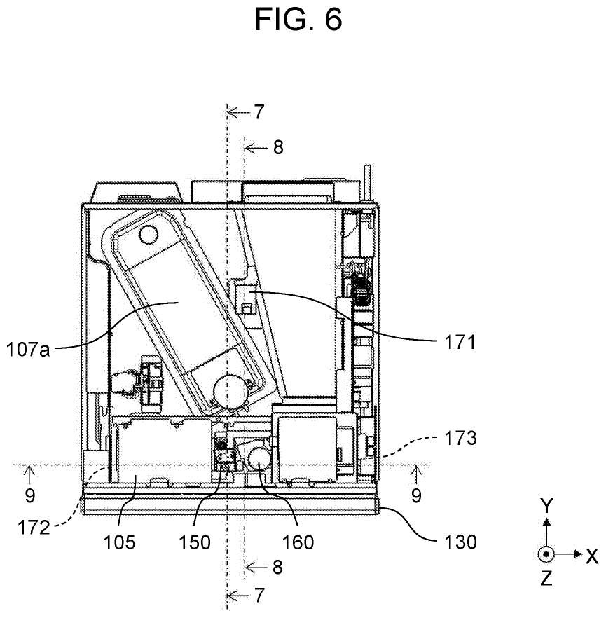

On an upper part of the front face of chassis 100 and above door 120 there is provided operation unit 130 having a laterally elongated shape in front view. Operation unit 130 has: a plurality of operation switches 131 for a user to set how to cook; and a plurality of displays 132 to display a state of operation to a user. Operation switches 131 include buttons to choose various types of information, a start button to start cooking, and the like. Displays 132 display an operating state of heating cooking device 1, a state of operation by operation switches 131. Operation switches 131 and displays 132 are controlled by controller 105 (see FIGS. 5 and 6). Controller 105 may be configured with, for example, a central processing unit (CPU), a microcomputer, or a hardware logic.

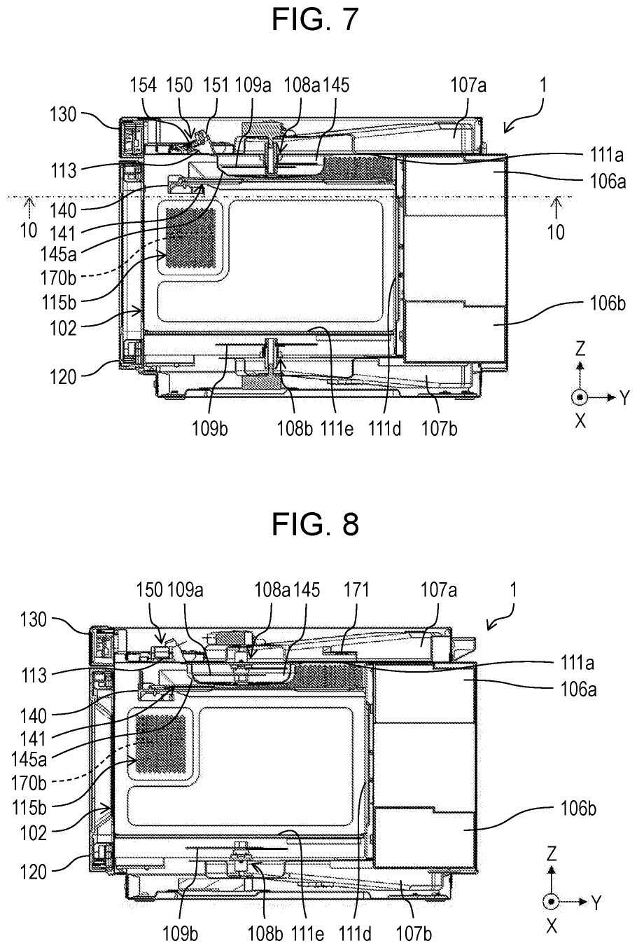

Heating cooking device 1 supplies at least one of microwaves (high-frequency waves), radiation heat, hot air, and steam to the inside of heating chamber 110 to heat an object to be heated placed on a bottom part of heating chamber 110. For this purpose, heating cooking device 1 includes as a heater serving as a heating means at least one of the followings: a high-frequency wave generator including magnetrons 106a, 106b to generate microwaves (see FIGS. 7 and 8); an upper heater unit (not shown) to heat, by radiation heat, an object to be heated; a convection heater unit (not shown) to circulate hot air in heating chamber 110; and a steam generator (not shown) to generate steam in heating chamber 110. In the present disclosure, two magnetrons 106a, 106b are included as a heater, which will be described later.

As shown in FIG. 4, in upper wall 111a of heating chamber 110 of heating cooking device 1 according to the one aspect of the present disclosure, there is provided wall surface opening 112 as an opening. Wall surface depression 113 formed in a recessed shape is provided upward from a circumferential edge of wall surface opening 112. Wall surface depression 113 is formed in a recessed shape obliquely upward from the circumferential edge of wall surface opening 112 provided in upper wall 111a of heating chamber 110.

In a bottom part, in other words, on the upward side of the recessed shape of wall surface depression 113, there is formed depression bottom opening 114 that is an opening for imaging. A side wall of wall surface depression 113 has a tapered shape that is narrower toward wall surface opening 112 from heating chamber 110.

Below upper wall 111a there is provided top panel 140 having a flat plate shape to be parallel to upper wall 111a with a space between top panel 140 and upper wall 111a. On a front side of top panel 140 there is provided top panel opening 141 as an opening.

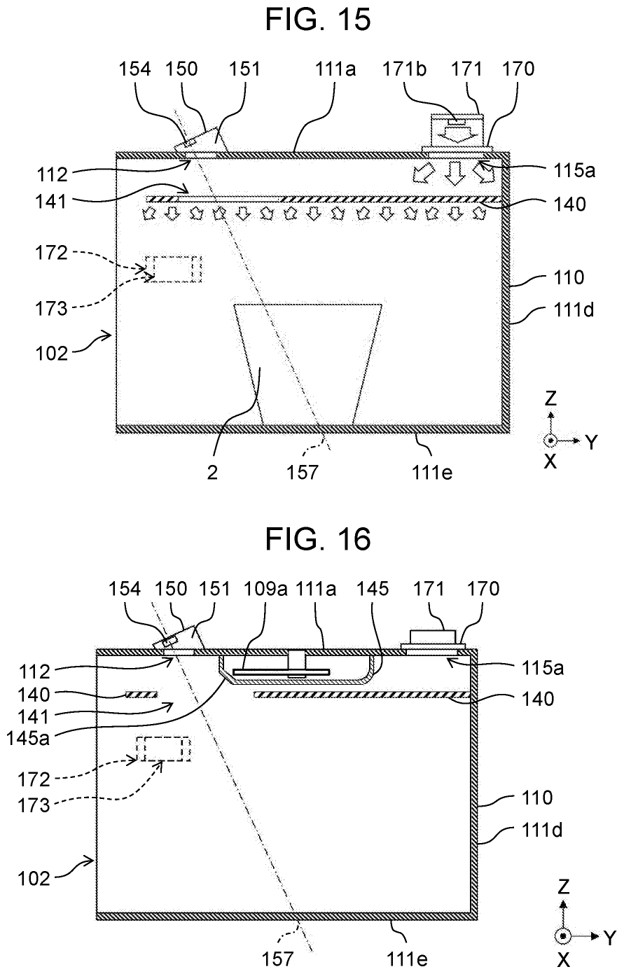

A side wall of wall surface depression 113 has a tapered shape that is narrower toward wall surface opening 112 from heating chamber 110. Depression bottom opening 114 is disposed to face the vicinity of camera 154 (see FIGS. 7 and 15). A cross-sectional area of an opening plane of depression bottom opening 114 is smaller than a cross-sectional area of an opening plane of wall surface opening 112. By making the opening of depression bottom opening 114 smaller as described above, it is possible to secure a wide field of view, and, at the same time, it is possible to prevent or reduce leakage of microwaves from the inside of heating chamber 110.

In the following, with reference to FIGS. 5 to 10, a description will be made on the followings: imaging unit 150; air blower 160; illuminators (upper illuminator 171 serving as a first illuminator, left illuminator 172 serving as a second illuminator, and right illuminator 173 serving as a third illuminator); disposition of top panel 140; and the like.

FIG. 5 is a perspective view showing heating cooking device 1 according to the one aspect of the present disclosure with an upper face and a side face of chassis 100 removed. FIG. 6 is a top view showing heating cooking device 1 according to the one aspect of the present disclosure with the upper face and the side face of chassis 100 removed.

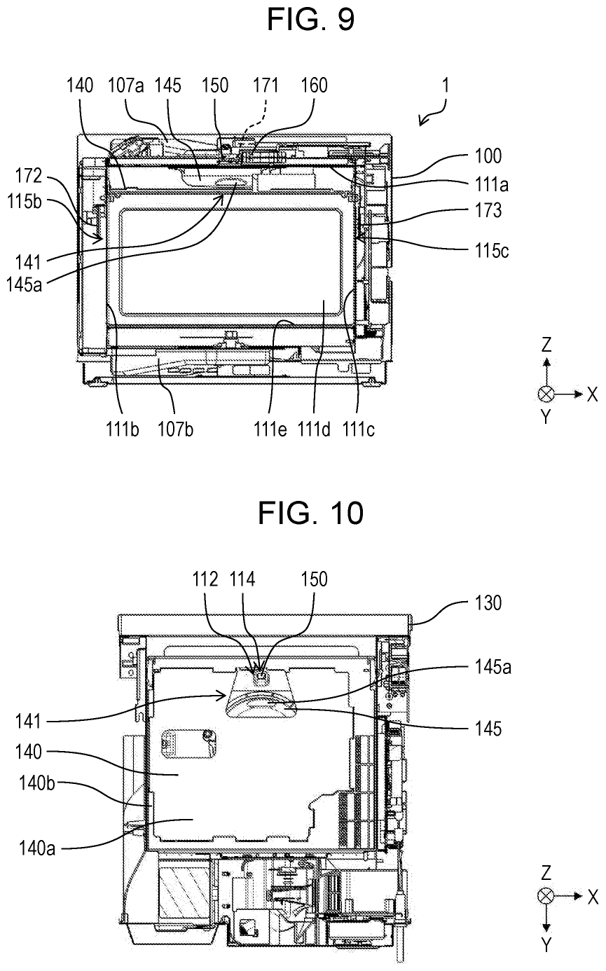

FIG. 7 is a cross-sectional view taken along line 7-7 of FIG. 6. FIG. 8 is a cross-sectional view taken along line 8-8 of FIG. 6. FIG. 9 is a cross-sectional view taken along line 9-9 of FIG. 6. FIG. 10 is a cross-sectional view taken along line 10-10 of FIG. 7.

As shown in FIGS. 7 and 8, two magnetrons 106a, 106b are each provided on one of an upper part and a lower part on the rear part of heating cooking device 1. Magnetrons 106a, 106b are respectively connected to waveguides 107a, 107b that transfer microwaves. Upper magnetron 106a is connected to waveguide 107a provided above upper wall 111a of heating chamber 110. Lower magnetron 106b is connected to waveguide 107b provided below bottom wall 111e of heating chamber 110. Waveguide 107a is connected to radiation opening 108a formed at an approximate center in heating chamber 110 as seen from above. Waveguide 107b is connected to radiation opening 108b formed at an approximate center in heating chamber 110 as seen from above, and below bottom wall 111e of heating chamber 110.

The microwaves generated by magnetrons 106a and 106b are respectively radiated from above and below into heating chamber 110 through waveguides 107a and 107b and radiation openings 108a and 108b. By radiating the microwaves from above and below, the object to be heated can be uniformly heated.

In the vicinity of each of radiation openings 108a, 108b, there is provided one of stirrers 109a and 109b. Stirrers 109a, 109b are rotating antennas and stir the microwaves radiated from radiation openings 108a, 108b to more uniformly heat the object to be heated.

Below stirrer 109a on the upper side, antenna cover 145 is provided to cover, from below, a rotation area of stirrer 109a.

Below antenna cover 145, top panel 140 is provided parallel to upper wall 111a of heating chamber 110. In top panel 140, top panel opening 141 is provided at a position on a forward side of top panel 140 and below imaging unit 150. Antenna cover 145 and top panel 140 will be described later in detail.

Above heating chamber 110, imaging unit 150 and air blower 160 are provided (see FIGS. 6 and 9). Above and on the sides of heating chamber 110, the illuminators (upper illuminator 171, left illuminator 172, and right illuminator 173) are provided to illuminate the inside of the chamber.

Imaging unit 150 has support frame 151, a camera substrate (not shown), camera 154, a shutter (not shown), and a drive motor (not shown).

Support frame 151 constituting imaging unit 150 is provided to cover wall surface depression 113 on an upper face of heating chamber 110. Imaging unit 150 is attached to face the inside of heating chamber 110 from the forward side of upper wall 111a of heating chamber 110, in other words, from a side that is closer to front face opening 102 than an approximate center of upper wall 111a is.

The camera substrate constituting camera 154 has an approximately rectangular flat plate shape, and camera 154 is attached such that the camera substrate is disposed at an approximate center of a surface of the camera substrate that is directed downward when support frame 151 is installed on upper wall 111a of heating chamber 110.

An imaging surface of camera 154 is formed in an approximately circular shape. As an imaging element of camera 154, a charge coupled device (CCD) or a complementary metal-oxide silicon (CMOS) device is used, for example. Camera 154 captures an image of the inside of heating chamber 110, on the basis of an instruction from controller 105.

The camera substrate is attached to support frame 151 in such a manner that an imaging opening, depression bottom opening 114, and wall surface opening 112 are disposed in line in an imaging direction of camera 154, in other words, in a direction of optical axis 157 as shown in FIG. 15. This arrangement enables camera 154 to face the inside of heating chamber 110 and to thus capture an image of the inside of heating chamber 110.

Imaging unit 150 includes a shutter (not shown) that is rotationally driven by a drive motor to protect camera 154 from steam and scattering substances from an object to be heated.

Since imaging unit 150 is provided on the wall on the upper side of heating chamber 110, in other words, on the ceiling side, imaging unit 150 can capture an image at an angle and position where imaging unit 150 looks down at heating chamber 110. This arrangement makes it possible to image a state of the upper side of the object to be heated more accurately, specifically, with a high resolution and a small trapezoidal distortion. The above configuration where an image is captured from the upper wall of heating chamber 110 is especially effective in the following usages: recognition of letters and symbols written on the upper surface of the object to be heated with high accuracy; recognition of a type of ingredient as the object to be heated; recognition of a shape and a size of the object to be heated; and recognition of a heating state of the object to be heated.

Heating cooking device 1 in the present disclosure can improve convenience of users in commercial use in convenience stores or other places and home use.

Imaging unit 150 is attached from the forward side of upper wall 111a of heating chamber 110, in other words, from a side that is closer to front face opening 102 than the center of upper wall 111a is. Further, imaging unit 150 is provided such that an imaging surface of camera 154 is inclined with respect to a horizontal plane such that the imaging direction is directed to an approximately central direction of bottom wall 111e of heating chamber 110. In other words, imaging unit 150 is provided to be inclined such that optical axis 157, which is the imaging direction of camera 154, is directed backward with respect to the vertical direction of heating chamber 110, in other words, such that optical axis 157 is directed away from front face opening 102. This arrangement makes it possible to dispose imaging unit 150 in a small space while avoiding the vicinity of the center of upper wall 111a seen from above. In the vicinity of the center of upper wall 111a, radiation opening 108a, which is an example of the heater and radiates microwaves, and other components are disposed. In the above configuration, imaging unit 150 is not disposed in the vicinity of the center of upper wall 111a but can image a large area in heating chamber 110 with high accuracy.

Since imaging unit 150 is provided with the imaging direction inclined backward with respect to the vertical direction, it is possible to prevent or reduce an influence, on imaging by imaging unit 150, caused by external light entering through glass window 122 of door 120. Specifically, it is possible to prevent deterioration of imaging accuracy of camera 154 caused by external light having entered through glass window 122 being directly or indirectly superposed with high luminance on an image captured by camera 154.

Air blower 160 has a fan case, a fan, and an exhaust port.

In the fan case, the fan is provided. The fan case has the exhaust port for blowing air. The fan is driven by a DC motor to generate an airflow flowing toward imaging unit 150. The fan is controlled on the basis of an instruction from controller 105.

Above and on the sides of heating chamber 110, the illuminators are provided to illuminate the inside of the chamber. The illuminators include upper illuminator 171, left illuminator 172, and right illuminator 173.

Upper illuminator 171 includes illumination substrate 171a, light emitting diodes (LEDs) 171b, and illumination support 171c.

On a surface, of illumination substrate 171a, toward heating chamber 110, the plurality of LEDs 171b are provided as light emitting elements, which are a light source. Since LEDs are used as a light source, it is possible to radiate a larger amount of light into heating chamber 110 with high reliability. Illumination substrate 171a is attached to illumination support 171c. Illumination support 171c is attached to upper wall 111a of heating chamber 110.

Light emission of the illuminators is controlled on the basis of an instruction from controller 105. Each of left illuminator 172 and right illuminator 173 includes constituent elements similar to illumination substrate 171a, LEDs 171b, and illumination support 171c of upper illuminator 171. Upper illuminator 171, left illuminator 172, and right illuminator 173 will be described later in detail.

### Configuration of Main Part

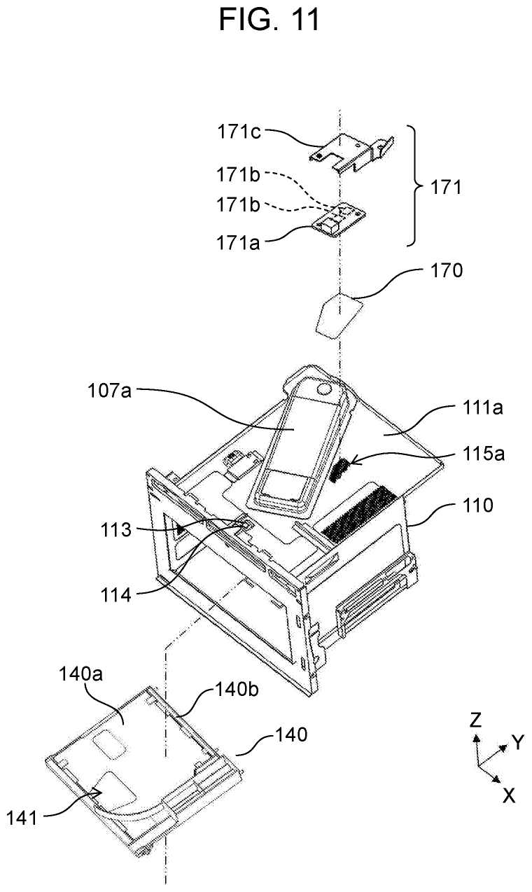

With reference to FIGS. 11 to 14, a detailed description will be made on the illuminators having upper illuminator 171, left illuminator 172, and right illuminator 173, top panel 140, and the surrounding area.

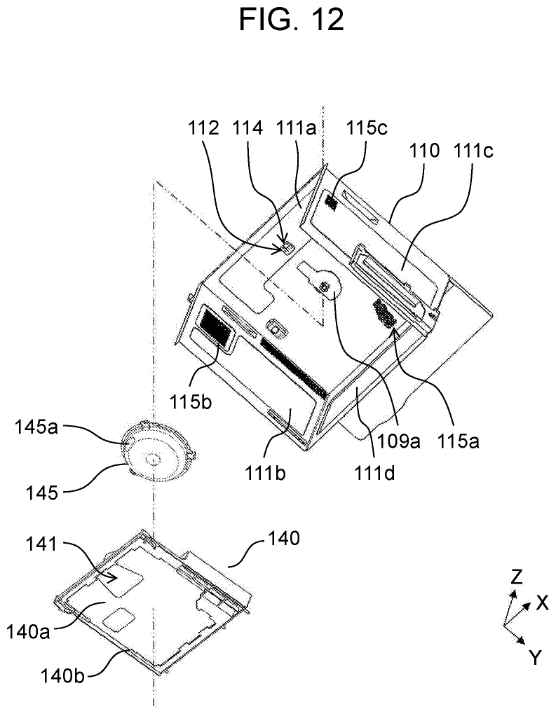

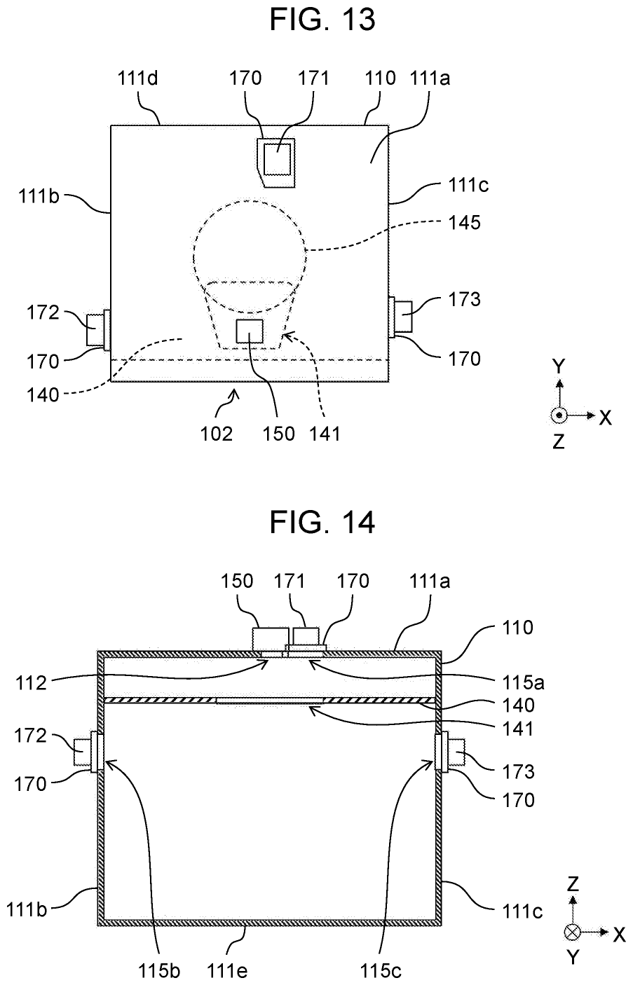

FIG. 11 is an exploded perspective view containing the illuminators, heating chamber 110, and top panel 140 of the heating cooking device according to the one aspect of the present disclosure. FIG. 12 is an exploded perspective view from below containing heating chamber 110, antenna cover 145, and top panel opening 141 of the heating cooking device according to the one aspect of the present disclosure. FIG. 13 is a top view schematic diagram illustrating the configuration and disposition of the illuminators and other components of the heating cooking device according to the one aspect of the present disclosure. FIG. 14 is a schematic diagram of a front view illustrating the configuration and disposition of the illuminators and other components of the heating cooking device according to the one aspect of the present disclosure.

In upper wall 111a of heating chamber 110, there is formed illumination opening 115a constituted by a plurality of punched holes at a position behind the center as seen from above. Illumination opening 115a is provided with diffuser sheet 170 to cover illumination opening 115a from outside. Further, on upper wall 111a of heating chamber 110, upper illuminator 171 is provided to face the inside of heating chamber 110 through diffuser sheet 170 and illumination opening 115a.

Upper illuminator 171 is disposed on the rear side with respect to the center of upper wall 111a of heating chamber 110 as seen from above. As seen from above, upper illuminator 171 and imaging unit 150 are disposed at opposite positions with respect to waveguide 107a, which is disposed on upper wall 111a to be inclined with respect to a front-back direction. In other words, upper illuminator 171 and imaging unit 150 are disposed at opposite positions with respect to radiation opening 108a as seen from above (see FIG. 8). This arrangement makes it possible to dispose upper illuminator 171 in a small space while avoiding the vicinity of the center seen from above, where various components are disposed.

In left-side wall 111b of heating chamber 110, there is formed illumination opening 115b constituted by a plurality of punched holes at a position on the front side and upper side as seen from side. Diffuser sheet 170 is provided to cover illumination opening 115b from outside. Further, on left-side wall 111b of heating chamber 110, left illuminator 172 is provided to face the inside of heating chamber 110 through diffuser sheet 170 and illumination opening 115b.

In right-side wall 111c of heating chamber 110, there is formed illumination opening 115c constituted by a plurality of punched holes at a position on the front side and upper side as seen from side. Diffuser sheet 170 is provided to cover illumination opening 115c from outside. Further, on right-side wall 111c of heating chamber 110, right illuminator 173 is provided to face the inside of heating chamber 110 through diffuser sheet 170 and illumination opening 115c.

Diffuser sheets 170 are each formed of a film whose main material is polyethylene terephthalate or polycarbonate. Each diffuser sheet 170 diffuses light radiated from one of the illuminations (upper illuminator 171, left illuminator 172, and right illuminator 173) toward directions perpendicular to the direction in which the light is radiated.

As shown in FIG. 12, at the center, seen from above, of upper wall 111a of heating chamber 110, there is provided stirrer 109a serving as the rotating antenna to stir microwaves. Stirrer 109a is provided below upper wall 111a to stir microwaves in heating chamber 110, in other words, stirrer 109a is provided in heating chamber 110.

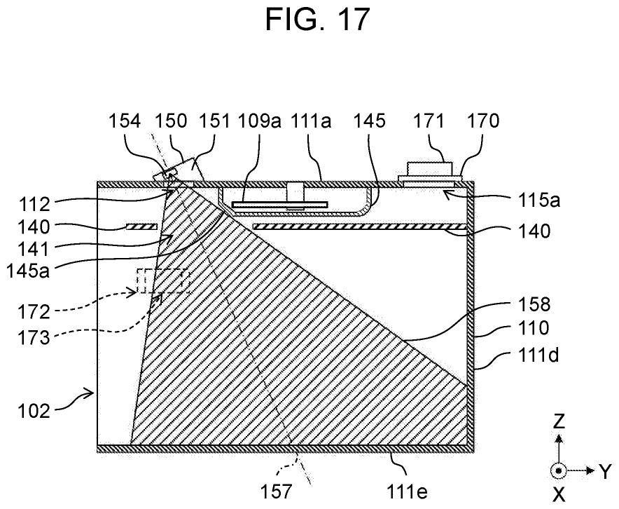

On a surface, of upper wall 111a, toward heating chamber 110, antenna cover 145 is provided to cover a rotation area of stirrer 109a from below. As shown in FIGS. 16 and 17, antenna cover 145 is provided below imaging unit 150 and above top panel 140. Antenna cover 145 is formed of a polypropylene material. With this arrangement, antenna cover 145 can be disposed in contact with the wall surface of heating chamber 110, which is heated to high temperatures, and, at the same time, microwaves radiated into heating chamber 110 can pass through antenna cover 145.

Antenna cover 145 has a bottomed bowl shape that is taper-shaped downward and has an opening at an upper part of antenna cover 145. Antenna cover 145 is attached such that an end part of the opening at the upper part is in contact with a lower surface of upper wall 111a. On a forward side of antenna cover 145, slope 145a is provided to be inclined with respect to a vertical direction of heating chamber 110. A lower side of slope 145a is inclined such that a downward side of slope 145a is directed toward the rear side of heating chamber 110.

As shown in FIGS. 11 to 14, below upper wall 111a, top panel 140 in a flat plate shape is provided parallel to upper wall 111a with a space between top panel 140 and upper wall 111a. Further, top panel 140 is provided below antenna cover 145.

Top panel 140 is constituted by flat plate 140a serving as a main surface and by peripheral edge part 140b of flat plate 140a. Flat plate 140a, which is the main surface of top panel 140, is formed of a laminated plate of glass cloth and silicone. This arrangement can let light pass through while gently diffusing the light, and can also let microwaves pass through. Peripheral edge part 140b of top panel 140 is formed of a polypropylene material. With this arrangement, antenna cover 145 can be disposed in contact with the wall surface of heating chamber 110, which is heated to high temperatures, and, at the same time, microwaves radiated into heating chamber 110 can pass through antenna cover 145. Since, as described above, flat plate part 140a of top panel 140 is formed of a material that is semitransparent and leads light in a planar direction, high-luminance light is diffused, and soft surface illumination is thus achieved.

Note that top panel 140 is configured also as a part of an air path to guide an airflow in heating chamber 110.

On a front side of top panel 140 there is provided top panel opening 141 as an opening. Since top panel opening 141 is provided in top panel 140, imaging unit 150 disposed on upper wall 111a of heating chamber 110 can image the inside of heating chamber 110.

However, in the case where top panel opening 141 is provided in top panel 140 to image the inside of heating chamber 110, there is a possibility for a user of heating cooking device 1 to touch stirrer 109a disposed on upper wall 111a through top panel opening 141. To avoid this issue, antenna cover 145 is provided between stirrer 109a and top panel 140. As shown in FIG. 13, antenna cover 145 is located in an opening of top panel opening 141 as seen from above. Since antenna cover 145 is disposed in this way, it is possible to prevent the user of heating cooking device 1 from touching stirrer 109a.

Upper illuminator 171 disposed on the upper surface of upper wall 111a is provided above top panel 140 as shown in FIG. 14, and left illuminator 172 and right illuminator 173 are provided below top panel 140. By this arrangement, illumination light from upper illuminator 171 disposed on the upper side of heating chamber 110, which is the same side as imaging unit 150 as seen from side, is converted into soft surface illumination light, and is radiated to object 2 to be heated. Therefore, an enough amount of light is supplied to the upper surface of object 2 to be heated, and, at the same time, it is possible to prevent occurrence of halation in an image captured by imaging unit 150, in other words, it is possible to prevent accuracy of the captured image from being deteriorated due to high-luminance light.

Since left illuminator 172 and right illuminator 173 are disposed below top panel 140, a larger amount of light can be supplied to heating chamber 110. Further, left illuminator 172 and right illuminator 173 are disposed on the front side of heating chamber 110, which is the same side as imaging unit 150 as seen from above, and illuminate the inside of heating chamber 110 with their main axes aligned with the horizontal direction. This arrangement prevents or reduces direct radiation of the illumination light emitted from left illuminator 172 and right illuminator 173 to imaging unit 150, and it is possible to prevent halation from occurring in a captured image.

### Action

With reference mainly to FIGS. 15 to 17, action of heating cooking device 1 of the present disclosure will be described below.

FIG. 15 is a side view schematic diagram illustrating a relation with respect to the illumination related to the illuminators and top panel 140 of the heating cooking device according to the one aspect of the present disclosure. FIG. 16 is a side view schematic diagram illustrating a relation with respect to an imaging direction related to imaging unit 150 of the heating cooking device according to the one aspect of the present disclosure. FIG. 17 is a side view schematic diagram illustrating a relation with respect to a viewing angle related to imaging unit 150 of the heating cooking device according to the one aspect of the present disclosure.

As shown in FIG. 15, upper illuminator 171 is provided on the rear side as seen from above, of upper wall 111a of heating chamber 110. Upper illuminator 171 includes the plurality of LEDs 171b serving as a light source with lighting directions of LEDs 171b directed downward. Each LED 171b is a light source using as an element an LED having high luminance and strong directionality.

The light radiated from LEDs 171b propagates almost straight downward, in other words, toward heating chamber 110. The right radiated from LEDs 171b reaches diffuser sheet 170 disposed below upper illuminator 171. Diffuser sheet 170 diffuses the light having entered in a planar direction of the sheet. That is, the light radiated from LEDs 171b is radiated downward while being diffused in the horizontal direction by diffuser sheet 170.

The light diffused by diffuser sheet 170 enters heating chamber 110 through illumination opening 115a constituted by a plurality of punched holes. Since illumination opening 115a is constituted by the punched holes each having a small opening, it is possible to prevent or reduce leakage of microwaves outside heating chamber 110 from the inside of heating chamber 110 through illumination opening 115a. Since illumination opening 115a is constituted by the plurality of punched holes, leakage of microwaves is prevented or reduced, and, at the same time, a large amount of light can be supplied into heating chamber 110.

The light having entered heating chamber 110 from illumination opening 115a reaches top panel 140 while spreading horizontally. Since top panel 140 is formed of a semitransparent material, the high-luminance light having reached passes through downward toward heating chamber 110 while spreading horizontally. This arrangement can reduce concentration of luminance and, at the same time, supply an enough amount of light to the upper surface of object 2 to be heated placed in heating chamber 110.

Inside the flat plate, top panel 140 guides the incident light in the planar direction, in other words, in the horizontal direction. This arrangement makes it possible to illuminate, from top panel 140, a wider area inside the heating chamber 110. As a result, an enough amount of light can be supplied more widely to the upper surface of object 2 to be heated placed in heating chamber 110.

As described above, with the present disclosure, although LEDs, which are point light sources having strong directionality and high luminance, are used as the light source, the illuminator can prevent luminance from increasing locally and, at the same time, the illuminator can illuminate a large area in heating chamber 110, supply a large amount of light, and illuminate the inside of heating chamber 110 from above as a surface light source.

Imaging unit 150 is provided on the front side of upper wall 111a of heating chamber 110, in other words, the side closer to front face opening 102. Imaging unit 150 is provided such that the imaging direction of camera 154, in other words, optical axis 157 is inclined to be directed backward with respect to the vertical direction of heating chamber 110.

Imaging unit 150 faces the inside of heating chamber 110 through wall surface opening 112 provided in upper wall 111a and through top panel opening 141 provided in top panel 140.

That is, imaging unit 150 captures an image with optical axis 157 directed to the inside of heating chamber 110 through wall surface opening 112 formed in upper wall 111a and top panel opening 141 formed in top panel 140.

The illumination light radiated from upper illuminator 171 is applied to object 2 to be heated through diffuser sheet 170 and top panel 140. That is, the illumination on object 2 to be heated from above is soft surface illumination. With this arrangement, a large area of an upper part of object 2 to be heated is illuminated by a large amount of light whose luminance is reduced. Therefore, although optical axis 157 of imaging unit 150 is inclined to be directed toward object 2 to be heated, light reflected from object 2 to be heated is supplied while being reduced in luminance but having an enough amount of light. Therefore, when imaging unit 150 captures an image, it is possible to prevent or reduce occurrence of halation in a captured image due to high luminance.

As described above, in the present disclosure, an enough amount of light can be supplied, and an exposure time (or a shutter open time) can be shortened. As a result, since an imaging time by imaging unit 150 can be shortened, operability of a user of heating cooking device 1 can be improved. Further, since the exposure time can be shortened, it is possible to prevent or reduce blur in an image captured by imaging unit 150 in a case where heating cooking device 1 vibrates. It is possible to supply an enough amount of light and, at the same time, to prevent or reduce occurrence of halation; therefore, in an application for recognizing a captured image as mentioned above, recognition accuracy can be improved.

As shown in FIGS. 13 to 15, left illuminator 172 is provided on the front side of left-side wall 111b of heating chamber 110, and right illuminator 173 is provided on the front side of right-side wall 111c of heating chamber 110.

Left illuminator 172 and right illuminator 173 radiate light in a right-left direction, in other words, in the horizontal direction. This arrangement makes it possible to supply an enough amount of light also to a lower part, in other words, lower positions in heating chamber 110. Further, since it is possible to prevent or reduce direct incidence of light on imaging unit 150 from left illuminator 172 and right illuminator 173, it is possible to reduce occurrence of halation in an image captured by imaging unit 150.

A plurality of illuminators, specifically, left illuminator 172 and right illuminator 173, are used below top panel 140. This arrangement can prevent or reduce luminance per one illuminator and, at the same time, increase the total amount of light; therefore, the inside of heating chamber 110 can be illuminated more uniformly, and it is possible to reduce occurrence of halation in an image captured by imaging unit 150.

As shown in FIG. 15, imaging unit 150 is provided such that optical axis 157 is inclined to be directed backward with respect to the vertical direction of heating chamber 110. Further, below imaging unit 150, top panel 140 is provided from a position of back wall 111d of heating chamber 110 to the vicinity of front face opening 102. This arrangement can prevent or reduce incidence, of external light that enters heating chamber 110 from the outside of heating cooking device 1 through front face opening 102, on camera 154 of imaging unit 150. This arrangement can prevent halation occurring in an image captured by imaging unit 150 due to external light.

Imaging unit 150 is disposed on the forward side of heating chamber 110 and is inclined to face backward. This arrangement can prevent or reduce incidence of external light on imaging unit 150 while the external light being reflected by the upper surface of object 2 to be heated placed in heating chamber 110, thereby reducing occurrence of halation in an image captured by imaging unit 150.

As shown in FIGS. 16 and 17, imaging unit 150 is provided such that optical axis 157 is inclined to be directed backward with respect to the vertical direction of heating chamber 110. Imaging unit 150 faces the inside of heating chamber 110 through wall surface opening 112 provided in upper wall 111a and through top panel opening 141 provided in top panel 140.

Field of view 158 shown in FIG. 17 represents an area that is imaged by imaging unit 150. Since top panel opening 141 is provided in top panel 140, imaging unit 150 can image object 2 to be heated placed in heating chamber 110 with a wide field of view 158.

Regarding a position of an end of the forward side of top panel opening 141, top panel opening 141 is formed such that a straight line starting from a position of camera 154 of imaging unit 150 and passing through an end part of the forward side of top panel opening 141 intersects a surface of bottom wall 111e of heating chamber 110. That is, top panel opening 141 is formed such that a front end of field of view 158 of camera 154 does not intersect front face opening 102. This arrangement can prevent or reduce direct incidence of the external light having entered through front face opening 102, on imaging unit 150. As a result, it is possible to prevent or reduce occurrence of halation in an image captured by imaging unit 150 due to external light.

As shown in FIGS. 13 and 17, as seen from above, the center of top panel opening 141 in the front-back direction is provided on the rear side with respect to the center of imaging unit 150. With this arrangement, also due to the configuration where imaging unit 150 is disposed to be inclined toward the back of heating chamber 110, it is possible to prevent or reduce incidence of external light coming through front face opening 102 and, at the same time, to ensure field of view 158 to be wide. As a result, imaging unit 150 can image object 2 to be heated placed in a large area in heating chamber 110.

However, since top panel opening 141 is provided in top panel 140, there is a possibility that a user of heating cooking device 1 touches stirrer 109a disposed on the upper part in heating chamber 110. In the present disclosure, antenna cover 145 is provided to cover stirrer 109a from below. As shown in FIG. 13, in a transparent view in the vertical direction, top panel opening 141, the imaging surface of imaging unit 150, and a part of antenna cover 145 are disposed to cover each other. This arrangement can prevent the user of heating cooking device 1 from touching stirrer 109a.

However, if antenna cover 145 is provided below upper wall 111a of heating chamber 110 so as to cover stirrer 109a, field of view 158 of imaging unit 150, which is also provided on upper wall 111a of heating chamber 110, is narrowed (see FIG. 17). In the present disclosure, as shown in FIGS. 16, 17, 12, and 4, slope 145a is provided on the front side of antenna cover 145, in other words, on a side, of antenna cover 145, toward imaging unit 150. Slope 145a is provided on the front side of antenna cover 145 in such a manner that slope 145a is along the inclination of a rear side of field of view 158. With this arrangement, a rear end of field of view 158 of camera 154 can be such a straight line that starts from the position of camera 154 of imaging unit 150 and passes an end part on the backward side of top panel opening 141. As a result, field of view 158 is not blocked by antenna cover 145 and is thus ensured to be wide.

As described above, regarding a position of the end of the backward side of top panel opening 141, top panel opening 141 is formed such that a straight line starting from the position of camera 154 of imaging unit 150 and passing the end part of the backward side of top panel opening 141 intersects a surface of back wall 111d of heating chamber 110. This arrangement enables imaging unit 150 to image a large area of the inside of heating chamber 110. Imaging unit 150 can image taller object 2 to be heated placed in heating chamber 110. In the present disclosure, it is possible to prevent or reduce incidence of external light and, at the same time, to image a large area of the inside of heating chamber 110. As a result, it is possible to image objects 2 to be heated having various heights. Further, it is possible to image object 2 to be heated placed at various positions on a bottom surface of heating chamber 110.

### Other Exemplary Embodiments

As described above, the above exemplary embodiment has been described as an example of the techniques disclosed in the present application. However, the techniques of the present disclosure can be applied not only to the above exemplary embodiment but also to exemplary embodiments in which modification, replacement, addition, or removal is appropriately made.

Therefore, other exemplary embodiments will be exemplified below.

In the above exemplary embodiment, a shutter is used to protect imaging unit 150 from steam and scattering substances from the object to be heated. However, a glass plate or another component may be provided on an imaging direction side of imaging unit 150 to protect imaging unit 150 from steam and scattering substances from the object to be heated.

In the above exemplary embodiment, LEDs are used as the light source. However, other than LEDs, it is possible to use a light source that emits a large amount of light and has a high luminance, for example, a laser light source or a halogen light source.

In the disclosed configuration, the illuminators include three illuminators, namely, upper illuminator 171, left illuminator 172, and right illuminator 173. However, the number of illuminators may be any number greater than or equal to one.

In the configuration described in the above exemplary embodiment, upper illuminator 171 is provided on the upper side of upper wall 111a of heating chamber 110. However, upper illuminator 171 only has to be disposed above top panel 140 to illuminate toward top panel 140.

In the above exemplary embodiment, flat plate 140a, which is the main surface of top panel 140, is constituted by a laminated plate of glass cloth and silicone. However, top panel 140 only has to be made of a semitransparent material that allows light to pass through while softly diffusing the light.

The main surface of top panel 140 is constituted by flat plate 140a. However, the main surface of top panel 140 may be constituted by a curved surface or a plurality of flat surfaces. Further, regarding top panel opening 141, a part of the circumference of the opening may be an open end as seen from above.

In the above exemplary embodiment, antenna cover 145 is formed of a polypropylene material. However, antenna cover 145 only has to be made of a flame-retardant material that is microwave permeable, and the usable material is not limited to the polypropylene material.

Antenna cover 145 is formed approximately circular as seen from above. However, antenna cover 145 only has to have such a shape that covers stirrer 109a and the heater, which are provided to be exposed below upper wall 111a of heating chamber 110.

According to one aspect of the present disclosure, a heating cooking device includes: a heating chamber having a front face opening; a heater that heats an object to be heated stored in the heating chamber; a camera that has an optical axis inclined with respect to a vertical direction and is disposed on an upper wall of the heating chamber to face inside of the heating chamber; and a first illuminator that radiates light toward the inside of the heating chamber from a position near the upper wall of the heating chamber. The heating cooking device further includes a top panel that is disposed below the upper wall of the heating chamber, includes a semitransparent member the diffuses the light from the first illuminator to illuminate downward, and includes a top panel opening serving as an opening through which the camera images the inside of the heating chamber.

This configuration makes it possible to prevent or reduce halation and, at the same time, to capture an image of an upper surface of the object to be heated with high accuracy.

According to one aspect of the present disclosure, on the upper wall of the heating chamber, the camera of the heating cooking device may be disposed closer to the front face opening than the center of the heating chamber seen from above is, and the optical axis is inclined toward a rear side of the heating chamber with respect to a vertical direction.

This configuration can prevent or reduce halation caused by light entering from outside of the heating cooking device.

According to one aspect of the present disclosure, the first illuminator of the heating cooking device may include an LED as a light source. This configuration can improve reliability of the light source and, at the same time, can supply a more amount of light.

According to one aspect of the present disclosure, on the upper wall of the heating chamber, the first illuminator of the heating cooking device may be disposed farther from the front face opening than the center of the heating chamber seen from above is. This configuration can supply the light reflected by the object to be heated, more to the imaging unit.

According to one aspect of the present disclosure, the camera and the first illuminator of the heating cooking device may be disposed to face each other with the center of the heating chamber interposed between the camera and the first illuminator as seen from above. This configuration can supply the light reflected by the object to be heated, more to the imaging unit.

According to one aspect of the present disclosure, below the top panel of the heating cooking device, there may be provided a second illuminator and a third illuminator each illuminating the inside of the heating chamber. This configuration can prevent halation and, at the same time, can supply a larger amount of light to the inside of the chamber.

According to one aspect of the present disclosure, each of the second illuminator and the third illuminator of the heating cooking device may be disposed one of the right and left side walls, of the heating chamber, facing each other at a position that is closer to the front face opening than an approximate center of the heating chamber seen from side is. This configuration can prevent halation and, at the same time, can supply an enough amount of light also to lower positions.

According to one aspect of the present disclosure, a heating cooking device includes: a heating chamber having an opening on a front face of the heating chamber; a heater that heats an object to be heated stored in the heating chamber; a camera that has an optical axis inclined with respect to a vertical direction and is disposed on an upper wall of the heating chamber to face inside of the heating chamber; and an illumination opening that is opened in the upper wall of the heating chamber. The heating cooking device includes: a first illuminator that is disposed more outside the heating chamber than the upper wall of the heating chamber and radiates light into the heating chamber through the illumination opening; and a top panel that is disposed more inside the heating chamber than the upper wall of the heating chamber, has a larger area as seen from above than the illumination opening, is formed not to overlap with the camera as seen from above, and is formed of a semitransparent material to allow light radiated from the first illuminator to pass through downward while diffusing the light.

This configuration makes it possible to prevent or reduce halation and, at the same time, to image an object to be heated having various heights with high accuracy.

### INDUSTRIAL APPLICABILITY

The present disclosure can be applied to a heating cooking device the inside of whose chamber is imaged by an imaging unit.

### REFERENCE MARKS IN THE DRAWINGS

1 heating cooking device

2 object to be heated

100 chassis

101 front frame

102 front face opening

105 controller

106a, 106b magnetron (heater)

107a, 107b waveguide (heater)

108a, 108b radiation opening (heater)

109a, 109b stirrer (antenna)

110 heating chamber

111a upper wall

111b left-side wall

111c right-side wall

111d back wall

111e bottom wall

112 wall surface opening

113 wall surface depression

114 depression bottom opening

115a, 115b, 115c illumination opening

120 door

121 handle

122 glass window

130 operation unit

131 operation switch

132 display

140 top panel

141 top panel opening

145 antenna cover

145a slope

150 imaging unit

151 support frame

154 camera

157 optical axis

158 field of view

160 air blower

170 diffuser sheet

171 upper illuminator (first illuminator)

171a illumination substrate

171b LED (light emitting diode)

171c illuminator support

172 left illuminator (second illuminator)

173 right illuminator (third illuminator)

1. A heating cooking device comprising:
a heating chamber having a front face opening;
a heater that heats an object to be heated stored in the heating chamber;
a camera that has an optical axis inclined with respect to a vertical direction and is disposed on an upper wall of the heating chamber to face inside of the heating chamber;
a first illuminator that radiates light toward the inside of the heating chamber from a position near the upper wall of the heating chamber; and
a top panel that is disposed below the upper wall of the heating chamber, includes a semitransparent member that diffuses the light from the first illuminator to illuminate downward, and includes a top panel opening serving as an opening through which the camera images the inside of the heating chamber.

2. The heating cooking device according to claim 1, wherein, when seeing from a top view, the camera is disposed closer to the front face opening than a center of the upper wall is, and
the optical axis is inclined toward a rear side of the heating chamber with respect to a vertical direction.

3. The heating cooking device according to claim 1, wherein the first illuminator includes a light emitting diode as a light source.

4. The heating cooking device according to claim 2, wherein the first illuminator includes a light emitting diode as a light source.

5. The heating cooking device according to claim 1, wherein, when seeing from a top view, the first illuminator is disposed farther from the front face opening than a center of the upper wall is.

6. The heating cooking device according to claim 1, wherein the camera and the first illuminator are disposed to face each other with a center of the upper wall interposed between the camera and the first illuminator.

7. The heating cooking device according to claim 1, further comprising
a second illuminator and a third illuminator that are disposed below the top panel, the second illuminator and the third illuminator each illuminating the inside of the heating chamber.

8. The heating cooking device according to claim 7, wherein
the second illuminator is disposed at a position on a left side wall of the heating chamber, the position of the second illuminator being closer to the front face opening than a center of the left side wall when viewed from a top view, and
the third illuminator is disposed at a position on a right side wall of the heating chamber, the position of the third illuminator being closer to the front face opening than a center of the right side wall when viewed from the top view, the right side wall facing the left side wall.

9. A heating cooking device comprising:
a heating chamber having an opening on a front face of the heating chamber;
a heater that heats an object to be heated stored in the heating chamber;
a camera that has an optical axis inclined with respect to a vertical direction and is disposed on an upper wall of the heating chamber to face inside of the heating chamber;
an illumination opening that is opened in the upper wall of the heating chamber;
a first illuminator that is disposed more outside the heating chamber than the upper wall of the heating chamber and radiates light into the heating chamber through the illumination opening; and
a top panel that is disposed more inside the heating chamber than the upper wall of the heating chamber, has a larger area as seen from above than the illumination opening, is formed not to overlap with the camera as seen from above, and is formed of a semitransparent material to allow light radiated from the first illuminator to pass through downward while diffusing the light.
